(19) United States
(12) Patent Application Publication
(10) Pub. No.: US 2026/0241729 A1
(43) Pub. Date: Aug. 20, 2026

(54) PRINTING APPARATUS

(71) Applicant: CANON KABUSHIKI KAISHA, Tokyo (JP)

(72) Inventors: TORU YADA, Kanagawa (JP); KANETO TOKUYAMA, Tokyo (JP); YUSUKE NAKAJIMA, Kanagawa (JP); TAKEHIRO NAKATA, Tokyo (JP); TAKAYUKI NAKAJIMA, Kanagawa (JP); MASAYA SHIMMACHI, Kanagawa (JP); RYO TAKANO, Kanagawa (JP); YASUHITO TSUBAKIMOTO, Tokyo (JP)

(21) Appl. No.: 19/545,970

(22) Filed: Feb. 20, 2026

(30) Foreign Application Priority Data
Feb. 20, 2025 (JP) 2025-026028

(51) Int. Cl. B41J 29/13; B41J 2/17; B41J 3/46; B41J 13/10

(52) U.S. Cl. CPC B41J 29/13; B41J 2/1728; B41J 3/46; B41J 13/103

(57) ABSTRACT

A printing apparatus includes a printing unit that performs printing on a print medium, a supply unit that supplies the printing unit with a printing material, a housing that has a front surface and accommodates the printing unit and the supply unit, a fixed operation unit that is fixed to the housing, on the front surface, a first movable member that is adjacent to the fixed operation unit, covers up to one end of the housing, and is movable with respect to the housing, on the front surface; and a second movable member that is adjacent to the first movable member in a height direction of the first movable member, covers from the one end to an other end of the housing, and is movable with respect to the housing, on the front surface.

### BACKGROUND

### Field of the Technology

The present disclosure relates to a printing apparatus.

### Description of the Related Art

There is a known front operation type liquid jet print apparatus in which an operation unit is arranged on a front surface of the apparatus.

As this type of apparatus, Japanese Patent Laid-Open No. 2020-146920 discloses a configuration in which a front surface portion of the apparatus includes a handle unit of an opening/closing member and an operation unit.

However, in a case where a cover member of the housing is present on the product front surface as in Japanese Patent Laid-Open No. 2020-146920, there is a problem that an access opening to the inside cannot be maximized.

In a case where the entire product front surface is an opening/closing unit, if the opening/closing unit is provided with an opening for cable insertion, opening/closing operation of the opening/closing unit is hindered in a state where a cable is connected.

### SUMMARY

The present disclosure has been made in view of the above-described problems, and maximizes an opening of an internal access unit in a front operation type printing apparatus.

An aspect of the present disclosure, there is provided a printing apparatus comprising: a printing unit that performs printing on a print medium by using printing material; a supply unit that supplies the printing unit with the printing material; a housing that has a front surface and a top surface on an upper side of the front surface and accommodates the printing unit and the supply unit; a fixed operation unit that includes an operation member and is fixed to the housing, on the front surface; a first movable member that is adjacent to the fixed operation unit, covers up to one end of the housing, and is movable with respect to the housing, on the front surface; and a second movable member that is adjacent to the first movable member in a height direction of the first movable member, covers from the one end to an other end of the housing, and is movable with respect to the housing, on the front surface.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are appearance views of a printing apparatus according to one embodiment of the present disclosure.

FIG. 2 is a view illustrating an internal structure of the printing apparatus of FIG. 1A.

FIG. 3 is a schematic diagram illustrating the internal structure of the printing apparatus of FIG. 1A.

FIG. 4 is a schematic diagram illustrating the internal structure of the printing apparatus of FIG. 1A.

FIG. 5 is a perspective view illustrating a state in which a front feeding unit is opened.

FIG. 6 is a side cross-sectional view illustrating a state in which the front feeding unit is opened.

FIG. 7 is a perspective view of a printing unit.

FIG. 8 is a cross-sectional view taken along line B-B of FIG. 7.

FIGS. 9A and 9B are layout diagrams of a front surface of the printing apparatus.

FIG. 10 is a cross-sectional view of the printing apparatus in a Z direction.

FIG. 11 is a perspective view of the front feeding unit.

FIG. 12 is a side view of a state in which a front feeding unit cover is opened.

FIGS. 13A and 13B are opening/closing state diagrams of a feeding tray.

FIGS. 14A and 14B are layout diagrams of a feeding sub-tray.

FIG. 15 is a perspective view of the front feeding unit cover in a closed state.

FIGS. 16A to 16C are perspective views illustrating an opening/closing state of a tank cover.

FIGS. 17A and 17B are perspective views illustrating the opening/closing state of the tank cover.

FIGS. 18A and 18B are views illustrating an opening/closing state of a cassette cover.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Outline of Printing Apparatus

In the present embodiment, a case where the present disclosure is applied to a serial type inkjet printing apparatus will be described, but the present disclosure is also applicable to other types of printing apparatuses.

Note that “printing” includes not only forming information having meaning, such as text, graphics, and the like, but also broadly includes forming any image, pattern, or the like, which does or does not have meaning, on a printing medium or processing the medium, regardless of whether the content is manifested in a way that can be perceived visually by humans. In the present embodiment, sheet-like paper is assumed as a “print medium”, but the print medium may be cloth, plastic film, or the like.

In each drawing, arrows X, Y, and Z indicate directions intersecting one another, the arrows X and Y indicate horizontal directions orthogonal to each other, and the arrow Z indicates a vertical direction. An X direction corresponds to the width direction of a printing apparatus 1, and a Y direction corresponds to the front-rear direction (depth direction) of the printing apparatus 1. A Z direction corresponds to the height direction of the printing apparatus 1. In a case of the downstream side and the upstream side, the conveyance direction of the print medium is used as a reference.

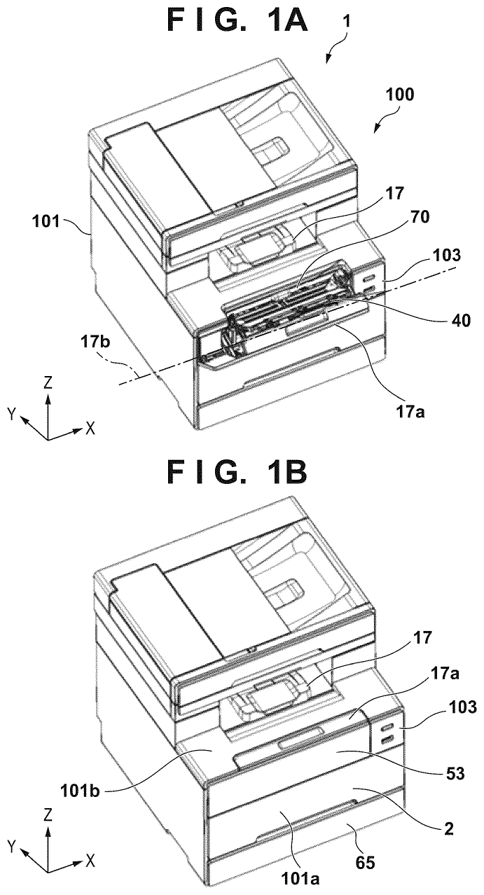

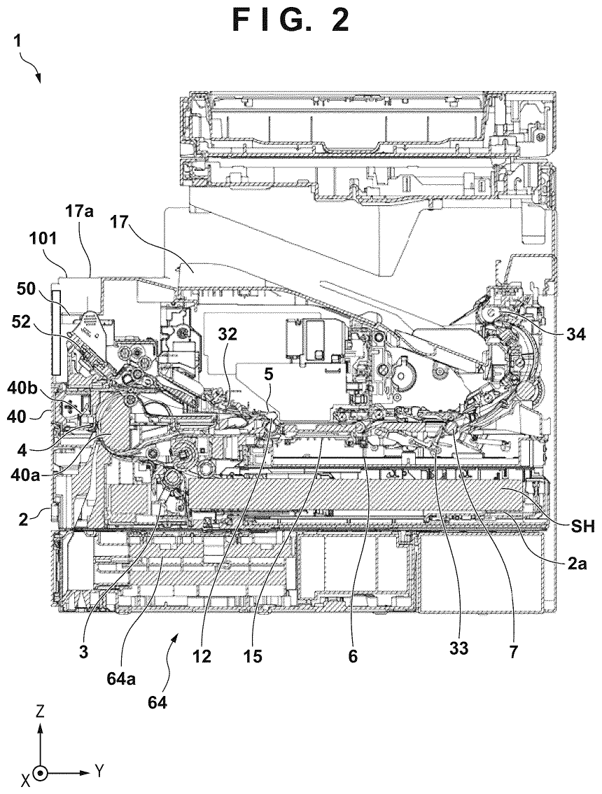

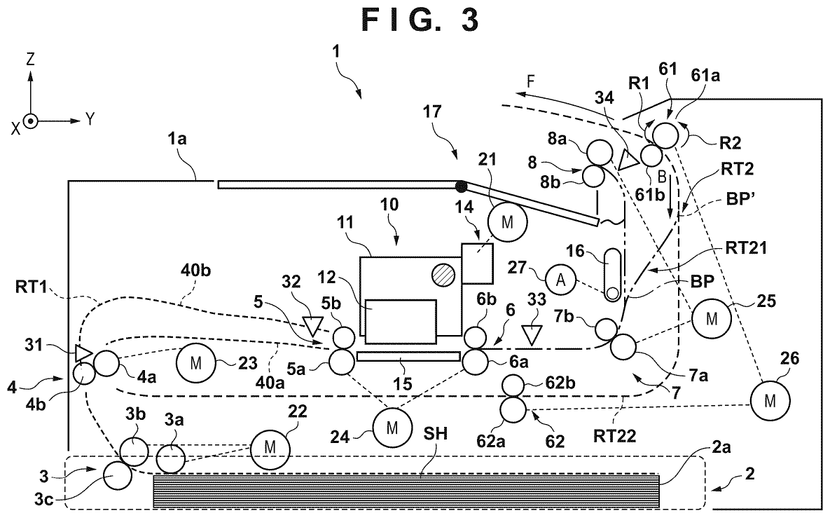

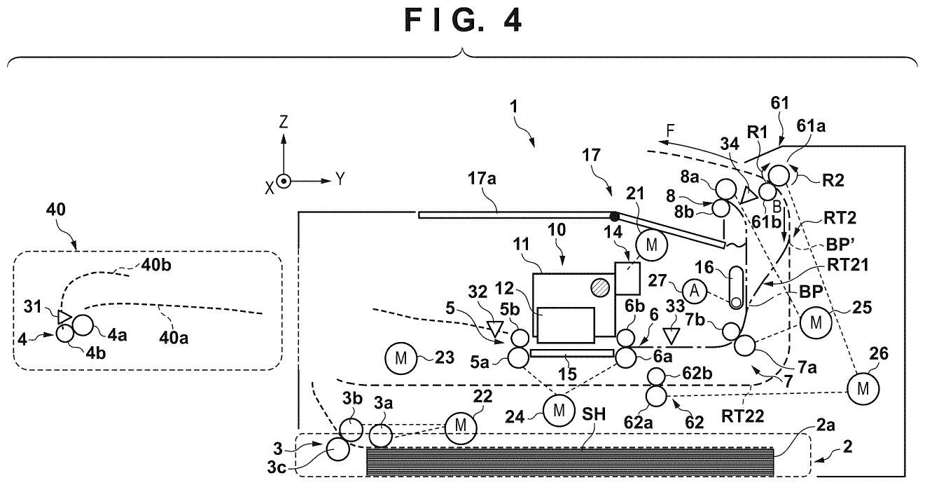

FIGS. 1A and 1B are appearance views of the printing apparatus 1 according to one embodiment of the present disclosure. FIG. 2 is a side cross-sectional view of the printing apparatus 1 as viewed from the X direction. FIG. 3 is a schematic view illustrating a main part of FIG. 2 in a more simplified manner, and FIG. 4 is a view illustrating a state in which a detachable unit 40 is removed in FIG. 3.

In FIGS. 1A to 4, the printing apparatus 1 includes a main body 100, an accommodation cassette 2 detachable from the main body 100, and the detachable unit 40. The main body 100 includes a housing 101 having a substantially rectangular parallelepiped shape, and the housing 101 forms an outer wall of the printing apparatus 1. The accommodation cassette 2 for accommodating a print medium (sheet SH), a front feeding unit cover 53 described later, and a tank cover 65 for accessing an ink tank accommodation unit (supply unit) 64 are arranged on a front surface 101a of the housing 101 constituting a front portion of the printing apparatus 1. The accommodation cassette 2 is positioned below the detachable unit 40, and facilitates securing of an accommodating amount of the print medium and securing of a feeding path.

An opening portion 70 for exposing the inside of the printing apparatus 1 is formed on an upper surface of the housing 101 forming the upper portion of the main body 100. The opening portion 70 is opened/closed by an opening/closing member 17a. In a case of the present embodiment, the opening/closing member 17a is a plate-like member constituting a part of a discharge tray 17, and is a rotating member provided rotatably around a rotation center axis 17b in the X direction. FIG. 1A illustrates a state in which the opening/closing member 17a is in an open state and the opening portion 70 is opened. When the opening/closing member 17a is brought into a closed state as in FIG. 1B, the opening portion 70 is closed.

FIGS. 2 to 4 are views illustrating the internal structure of the printing apparatus 1. The printing apparatus 1 performs printing on the sheet SH, which is a print medium before printing, stacked on a feeding tray 2a in the accommodation cassette 2. The printing apparatus 1 discharges the sheet SH having been printed to the discharge tray 17. The accommodation cassette 2 can be detached from the main body 100 of the printing apparatus 1, and the sheet SH can be set on the feeding tray 2a of the accommodation cassette 2 having been removed.

A main conveyance path RT1 for guiding conveyance of the sheet SH is formed from the feeding tray 2a to the discharge tray 17. The printing apparatus 1 also includes a sub conveyance path RT2 branching from the main conveyance path RT1 at a branch point BP. The sub conveyance path RT2 is an inversion path that inverts the front and back of the sheet SH and returns the sheet SH to the main conveyance path RT1, and is used in a case of performing double-sided printing of the sheet SH. Note that the printing apparatus 1 may have configuration not including a double-sided printing function of the sheet SH, and in this case, the sub conveyance path RT2 and the related configuration are unnecessary.

Note that the main conveyance path RT1 and the sub conveyance path RT2 are formed by path forming members. As an example of the path forming member, FIGS. 3 and 4 illustrate an upper path forming member 40b and a lower path forming member 40a in a section between a second feeding unit 4 and a conveyance unit 5. The conveyance path is defined by such path forming members.

The sheets SH in the feeding tray 2a are introduced one by one into the main conveyance path RT1 by a first feeding unit (second supply mechanism) 3. The first feeding unit 3 is a pickup mechanism that picks up the sheet SH from the feeding tray 2a using a feeding motor 22 as a drive source. The first feeding unit 3 includes a feeding roller (pickup roller) 3a, a feeding roller 3b, and a separation roller 3c.

The feeding roller 3a contacts the uppermost surface of the sheet SH stacked on the feeding tray 2a to rotate by driving from the feeding motor 22 and start feeding the sheet SH. The feeding roller 3b that rotates by driving from the feeding motor 22 and the separation roller 3c that forms a nip portion with the feeding roller 3b are arranged downstream of the feeding roller 3a. The separation roller 3c is a roller including a torque limiter and having rotational resistance. When two or more sheets SH enter the nip portion between the feeding roller 3b and the separation roller 3c, a single sheets SH is separated by the rotational resistance of the separation roller 3c.

The printing apparatus 1 includes the second feeding unit 4 and a plurality of conveyance units 5 to 8. The second feeding unit 4, the conveyance unit 5, the conveyance unit 6, the conveyance unit 7, and the conveyance unit 8 are arranged in this order from the upstream side to the downstream side in the conveyance direction of the sheet SH in the main conveyance path RT1. Conveyance units 61 and 62 are arranged along the sub conveyance path RT2, and the conveyance unit 61 and the conveyance unit 62 are arranged in this order from the upstream side to the downstream side in the conveyance direction of the sheet SH in the sub conveyance path RT2. Note that in the following description, unless otherwise specified, a leading end and a trailing end of the sheet SH mean a downstream end and an upstream end of the sheet SH.

The second feeding unit 4 conveys, to the conveyance unit 5, the sheet SH introduced into the main conveyance path RT1 by the first feeding unit 3 or the sheet SH returned from the sub conveyance path RT2 to the main conveyance path RT1. The second feeding unit 4 includes a feeding roller 4a and a driven roller 4b pressed against the feeding roller 4a by a spring or the like not illustrated. The feeding roller 4a is a rotating body that rotates by the driving force of a feeding motor 23, and the driven roller 4b is a rotating body that rotates following the rotation of the feeding roller 4a.

The sheet SH is nipped at a nip portion between the feeding roller 4a and the driven roller 4b, and is conveyed by the rotation of the feeding roller 4a and the driven roller 4b. Note that the feeding rollers 3a and 3b are one-way rollers, and after conveying the sheet SH to a position beyond the nip portion of the second feeding unit 4, the conveyance can be continued by the second feeding unit 4 even if the driving of the first feeding unit 3 is stopped.

A sensor 31 is a sensor that detects the passage of the leading end and the trailing end of the sheet SH, and is, for example, an optical sensor. The detection position of the sensor 31 is set at a position downstream of the nip portion of the second feeding unit 4. After the passage of the leading end of the sheet SH is detected, the detection result of the sensor 31 can be used as a trigger of control, such as stopping the driving of the first feeding unit 3 or increasing the conveyance speed of the second feeding unit 4.

The conveyance unit 5 is arranged upstream of a printhead 12, and the sheet SH is conveyed downstream between the printhead 12 and a platen 15 facing the printhead 12 by the conveyance unit 5. The conveyance unit 5 includes a conveying roller 5a and a driven roller (pinch roller) 5b pressed against the conveying roller 5a by a spring or the like not illustrated. The conveying roller 5a is a rotating body that rotates by the driving force of a conveyance motor 24, and the driven roller 5b is a rotating body that rotates following the rotation of the conveying roller 5a. The sheet SH is nipped at a nip portion between the conveying roller 5a and the driven roller 5b, and is conveyed by the rotation of the conveying roller 5a and the driven roller 5b.

Similarly to the sensor 31, a sensor 32 is a sensor that detects the passage of the leading end and the trailing end of the sheet SH, and is an optical sensor. The sensor 32 is arranged upstream in the vicinity of the conveyance unit 5, and therefore the detection result thereof can be used for management of the loop amount of registration adjustment of the sheet SH and the leading end position of the sheet SH.

The conveyance unit 6 is arranged downstream of the printhead 12, and conveys, to the conveyance unit 7 on the downstream side, the sheet SH conveyed by the conveyance unit 5. The conveyance unit 6 includes a conveying roller 6a and a spur 6b pressed against the conveying roller 6a by a spring or the like not illustrated. The conveying roller 6a is a rotating body that rotates by the driving force of the conveyance motor 24, and the spur 6b is a rotating body that rotates following the rotation of the conveying roller 6a. In the present embodiment, the conveyance unit 5 and the conveyance unit 6 share the drive source (motor 24).

A sensor 33 is an optical sensor similar to the sensors 31 and 32, and is used for detecting the leading end and the trailing end of the sheet SH.

The conveyance unit 7 is arranged downstream of the printhead 12 and the conveyance unit 6, and conveys downstream the sheet SH conveyed by the conveyance unit 6. The conveyance unit 7 includes a conveying roller 7a and a driven roller 7b pressed against the conveying roller 7a by a spring or the like not illustrated. The conveying roller 7a is a rotating body that rotates by the driving force of a conveyance motor 25, and the driven roller 7b is a rotating body that rotates following the rotation of the conveying roller 7a. The sheet SH is nipped at a nip portion between the conveying roller 7a and the driven roller 7b, and is conveyed by the rotation of the conveying roller 7a and the driven roller 7b.

The conveyance unit 8 is a discharge unit that is arranged downstream of the printhead 12 and the conveyance units 6 and 7, and discharges, to the discharge tray 17, the sheet SH conveyed by the conveyance unit 7. In a case of single-sided printing, the sheet SH discharged to the discharge tray 17 is discharged in a “face-down discharge” in which the printing surface of the image faces downward. In a case of double-sided printing, the second printing surface faces downward. In the main conveyance path RT1, a path from the conveyance unit 6 to the conveyance unit 8 may be called a “discharge conveying path”.

The conveyance unit 8 includes a conveying roller 8a and a driven roller 8b pressed against the conveying roller 8a by a spring or the like not illustrated. The conveying roller 8a is a rotating body that rotates by the driving force of the conveyance motor 25, and the driven roller 8b is a rotating body that rotates following the rotation of the conveying roller 8a. The sheet SH is nipped at a nip portion between the conveying roller 8a and the driven roller 8b, and is conveyed by the rotation of the conveying roller 8a and the driven roller 8b.

In the present embodiment, the conveyance unit 7 and the conveyance unit 8 share the drive source (conveyance motor 25). However, the conveyance motor 25 may be eliminated, and the conveyance motor 24, which is the drive source of the conveyance unit 5 and the conveyance unit 6, may be shared by the conveyance unit 7 and the conveyance unit 8.

A sensor 34 is an optical sensor similar to the sensors 31 to 33, and is used for detecting the leading end and the trailing end of the sheet SH. In the present embodiment, after the trailing end of the sheet SH is detected by the sensor 34, discharge is completed after a predetermined amount of conveyance, and the detection result of the sensor 34 can also be used for discharge detection.

A flapper 16 is arranged at the branch point BP. The flapper 16 switches the path of the conveying destination of the sheet SH between the main conveyance path RT1 and the sub conveyance path RT2. In the positions of FIGS. 3 and 4, the flapper 16 maintains the path of the conveying destination of the sheet SH in the main conveyance path RT1, and the sheet SH is discharged to the discharge tray 17 via the conveyance unit 8. The flapper 16 is rotatably provided, and is rotated by an actuator 27 such as an electromagnetic solenoid to switch the path.

The conveyance unit 61 is an inverting unit that conveys the sheet SH that has entered the sub conveyance path RT2 from the branch point BP. The sub conveyance path RT2 includes an inversion path RT21 extending upward from the branch point BP via a branch point BP′ and a return path RT22 extending from the branch point BP′ to the second feeding unit 4, and constitutes a path for guiding the sheet SH from the rear side to the front side of the printing apparatus 1. The conveyance unit 61 is arranged in the inversion path RT21. The conveyance unit 61 includes a conveying roller 61a and a driven roller 61b pressed against the conveying roller 61a by a spring or the like not illustrated. The conveying roller 61a is a rotating body that rotates by the driving force of a conveyance motor 26, and the driven roller 61b is a rotating body that rotates following the rotation of the conveying roller 61a.

The sheet SH that has entered the sub conveyance path RT2 from the branch point BP moves along the inversion path RT21. The conveying roller 61a is rotated in both an R1 direction and an R2 direction opposite thereto. By the conveying roller 61a rotating in the R1 direction, the sheet SH is conveyed in an arrow F direction. When the trailing end of the sheet SH passes through the branch point BP′, the rotation direction of the conveying roller 61a is switched to the R2 direction. The sheet SH is conveyed in the opposite direction. The front and back of the sheet SH are inverted and introduced into the return path RT22 from the branch point BP′.

The conveyance unit 62 is an intermediate unit arranged in the return path RT22. The conveyance unit 62 includes a conveying roller 62a and a driven roller 62b pressed against the conveying roller 62a by a spring or the like not illustrated. The conveying roller 62a is a rotating body that rotates by the driving force of the conveyance motor 26, and the driven roller 62b is a rotating body that rotates following the rotation of the conveying roller 62a. The sheet SH is nipped at a nip portion between the conveying roller 62a and the driven roller 62b, and is conveyed by the rotation of the conveying roller 62a and the driven roller 62b. In the present embodiment, the conveyance unit 61 and the conveyance unit 62 share the drive source (motor 26).

Note that the conveying roller 62a is a one-way roller, and after the sheet SH is conveyed to a position beyond the nip portion of the second feeding unit 4, the conveyance by the second feeding unit 4 can be continued even if the driving of the conveying roller 62a is stopped.

### Front Feeding Unit

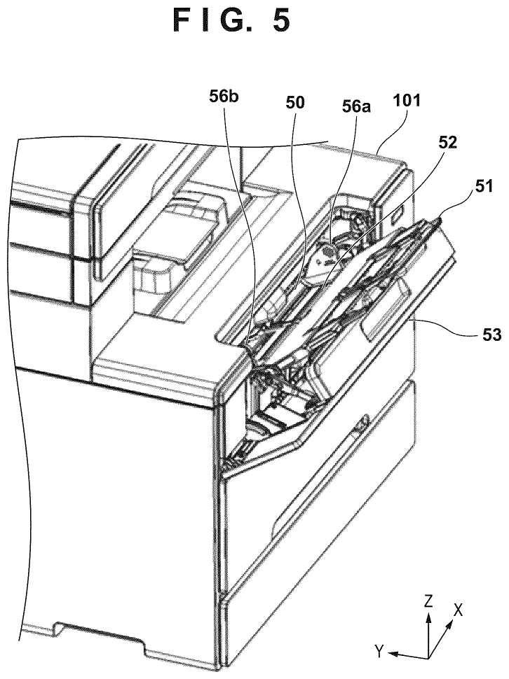

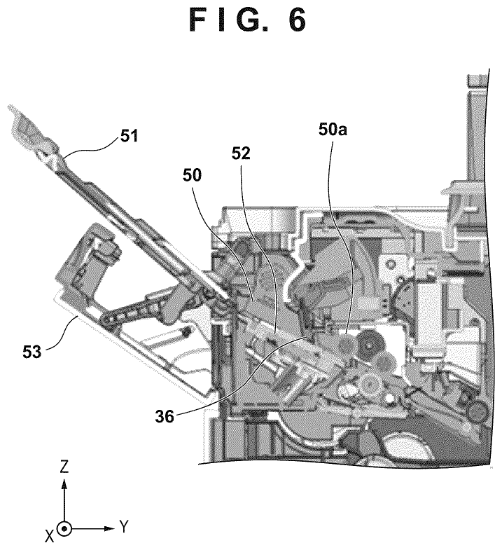

A front feeding unit 50 will be described with reference to FIGS. 5 and 6. FIG. 5 illustrates a state in which a part of FIG. 1A is enlarged, and is a view illustrating a state in which the front feeding unit cover 53 and a feeding tray 51 are drawn out. FIG. 6 is a view illustrating the internal structure in a state where the front feeding unit cover 53 and the feeding tray 51 are drawn out from the state of FIG. 2.

Inside the housing 101, the front feeding unit (first supply mechanism) 50 is arranged above the feeding tray 2a for feeding the sheet SH in the Z direction (+Z direction) and at the front surface 101a side of the printing apparatus 1. FIG. 2 illustrates a state in which the feeding tray 51 of the front feeding unit 50 is closed, and FIGS. 5 and 6 illustrate a state in which the feeding tray 51 is open. In a state where the feeding tray 51 is closed, a plurality of trays are folded and accommodated inside the housing 101, and in a state where the feeding tray 51 is open, the plurality of folded trays are extended to have a length that can hold the stacked sheet SH so as not to fall.

A stacking tray 52 is arranged behind the feeding tray 51 that is open, and the sheet SH that is stacked is held by both the feeding tray 51 and the stacking tray 52. A feeding roller 50a that performs feeding by pressing against the sheet SH that is stacked is arranged behind the stacking tray 52. The stacking tray 52 includes a sensor 36 that detects whether or not the sheet SH is stacked.

The sensor 36 is, for example, an optical sensor similar to the other sensors 31 to 33. Unlike other sensors, the sensor 36 is not arranged for the purpose of detecting the leading end and the trailing end of the sheet SH, but arranged for the purpose of detecting the presence or absence of the sheet SH. Therefore, the sensor 36 can be configured by, for example, a reflective sensor or the like. Side guides 56a and 56b for supporting the width direction of the sheet SH that is stacked are attached to the left and right of the stacking tray 52. The left and right side guides 56a and 56b are connected by a rack and pinion (not illustrated), and therefore, when the user operates either of the side guides, the side guide on the opposite side also moves in conjunction, and the left and right ends of the sheet SH can be supported.

### Printing Unit

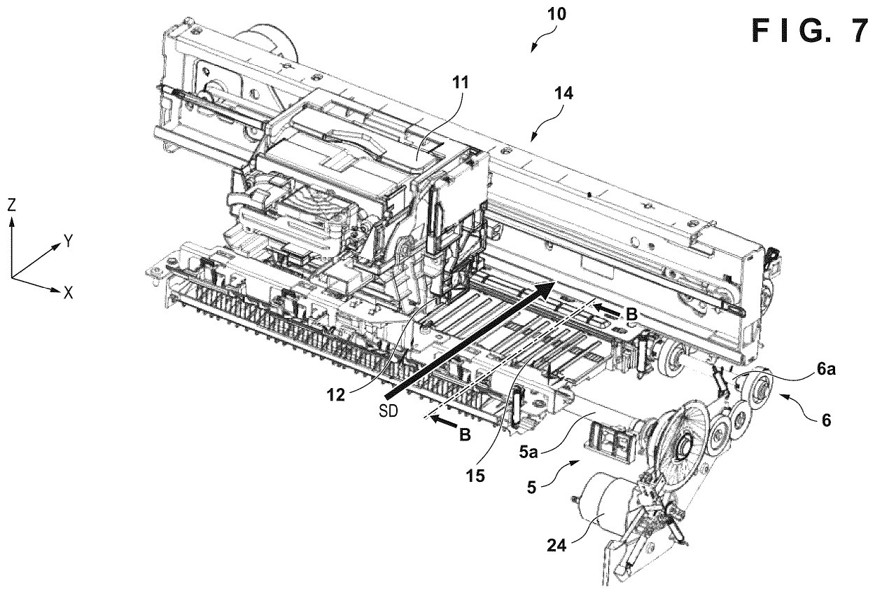

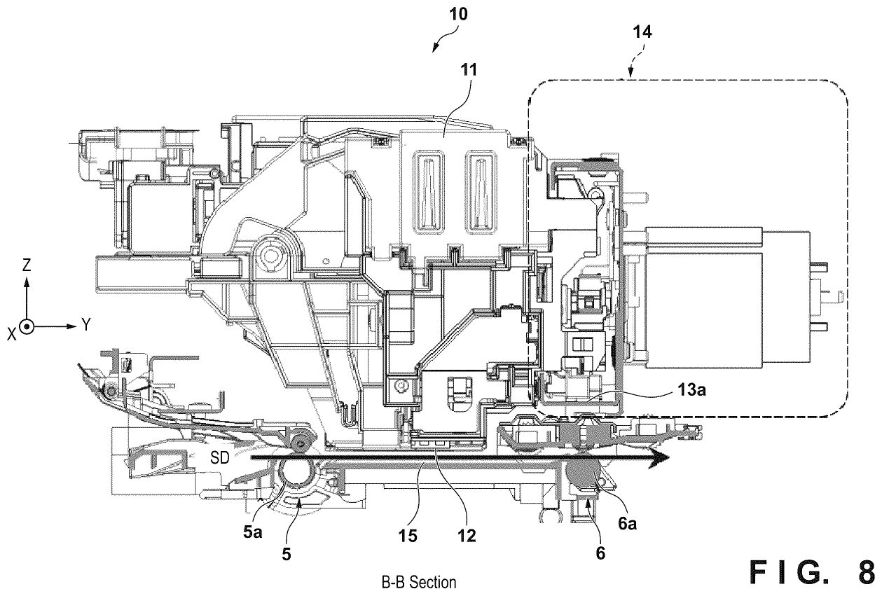

FIG. 7 is a perspective view of the printing unit, and FIG. 8 is a cross-sectional view taken along line B-B of FIG. 7. A printing unit 10 of the present embodiment will be described with reference to FIGS. 3, 4, 7, and 8.

The printing unit 10 includes the printhead 12, a carriage 11, and a driving unit 14. The printhead 12 ejects liquid ink (printing material) onto the sheet SH to be conveyed in a direction indicated by an arrow SD to print an image on the sheet SH. The printhead 12 has, on a lower surface thereof, an ejection surface on which a plurality of nozzles for ejecting ink are formed.

The ink supply system to the printhead 12 is, for example, a tube supply system performed through a tube (not illustrated) from an ink tank 64a (see FIG. 2) arranged inside the tank cover 65 at a location different from the carriage 11. However, the ink supply form includes an independent ink cartridge system in which the carriage 11 is equipped with an ink cartridge together with the printhead 12 and a head cartridge system in which the ink cartridge and the printhead 12 are integrated, and any method thereof may be adopted.

### Configuration of Front Surface Portion of Apparatus

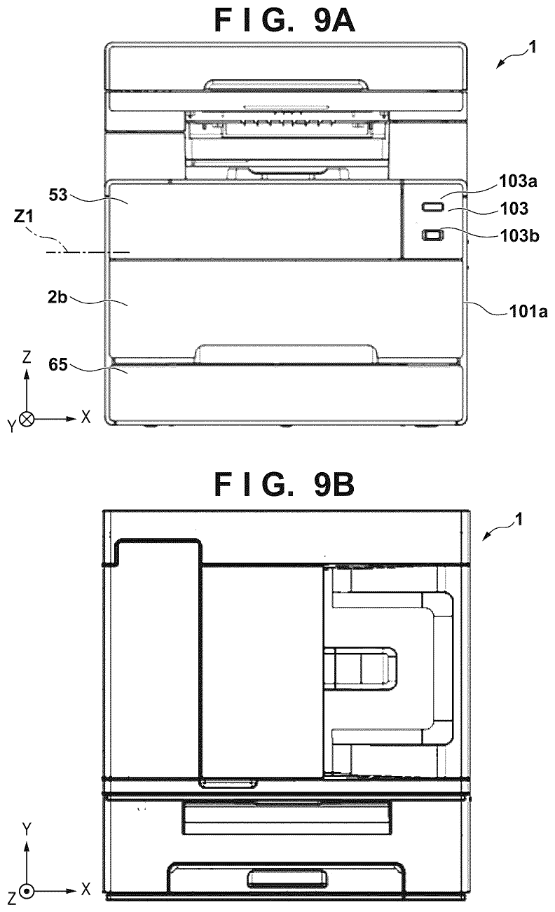

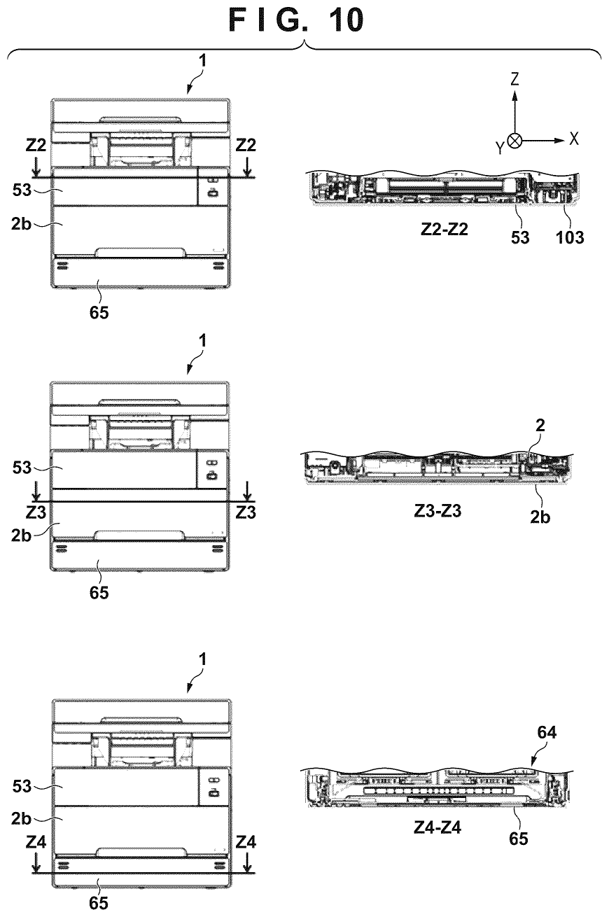

FIGS. 9A and 9B are views illustrating configurations of a front surface portion and an upper surface portion of the printing apparatus 1. FIG. 9A illustrates a front view and FIG. 9B illustrates a top view. FIG. 10 is a view illustrating each cross section of the printing apparatus 1 in the Z direction.

On the front surface 101a of the printing apparatus 1, the front feeding unit cover 53, the tank cover 65, and a cassette cover (appearance cover) 2b covering the front surface portion of the feeding tray 2a, which are a plurality of movable members, a fixed operation panel (fixed operation unit) 103, and a key 103a contained in the fixed operation panel 103 are arranged. On the fixed operation panel 103, a cable insertion terminal 103b for performing input/output of an electrical signal from the outside is arranged.

The housing 101 has, on both sides of the front surface 101a, a first side surface on the fixed operation panel 103 side and a second side surface opposite thereto. A top surface 101b is above the front surface 101a. The discharge tray 17 is at the back side of the top surface 101b. A reading unit 900 that reads a document is above the discharge tray 17. The print medium discharged to the discharge tray 17 is taken out from the opening between the top surface 101b and the reading unit 900. The surface on which the opening is formed is at a position retreated to the back surface side relative to the front surface 101a of the printing apparatus 1.

The front feeding unit cover 53 is adjacent to the fixed operation panel 103. The front feeding unit cover 53 and the fixed operation panel 103 form an end portion on the first side surface side to an end portion on the second side surface side at the frontmost side below the top surface 101b of the housing 101. That is, as illustrated in a Z2-Z2 cross section, a part of the first side surface of the housing 101 enters the inside of the front feeding unit cover 53 and is covered with the front feeding unit cover 53.

The cassette cover 2b adjacent to the front feeding unit cover 53 on the lower side extends from an end portion (one end portion) on the first side surface side to an end portion (the other end portion) on the second side surface side of the housing 101 at the frontmost side of the housing 101. That is, as illustrated in a Z3-Z3 cross section, a part of the first side surface and a part of the second side surface of the housing 101 enter the inside of the cassette cover 2b and are covered with the cassette cover 2b.

The tank cover 65 adjacent to the cassette cover 2b on the lower side extends from the end portion on the first side surface side to the end portion on the second side surface side of the housing at the frontmost side of the housing 101. That is, as illustrated in a Z4-Z4 cross section, a part of the first side surface and a part of the second side surface of the housing 101 enter the inside of the tank cover 65 and are covered with the tank cover 65.

Therefore, the front surface of the printing apparatus includes only the fixed operation panel including the operation member and the plurality of covers movable with respect to the printing apparatus.

### Configuration of Front Feeding Unit Cover

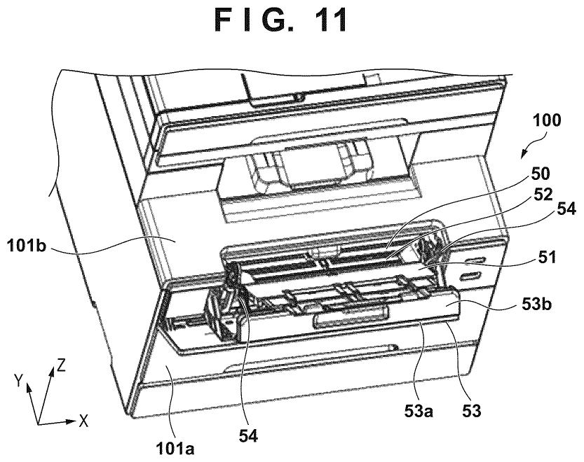

The front feeding unit cover 53 will be described with reference to FIG. 11. The front feeding unit cover 53 is integrally configured to include a surface 53a and a surface 53b continuous with the front surface 101a of the apparatus and the top surface 101b of the apparatus, respectively, and is axially supported to be openable with respect to the main body 100. The front feeding unit 50 includes the feeding tray 51, which is contained in the main body 100 when the front feeding unit cover 53 is in a closed state and is exposed from the main body 100 when the front feeding unit cover 53 is in an open state. The feeding tray 51 includes a tray link mechanism 54 that changes the position with respect to the front feeding unit 50 in conjunction with opening/closing of the front feeding unit cover 53.

### Lower End Position of Front Feeding Unit Cover

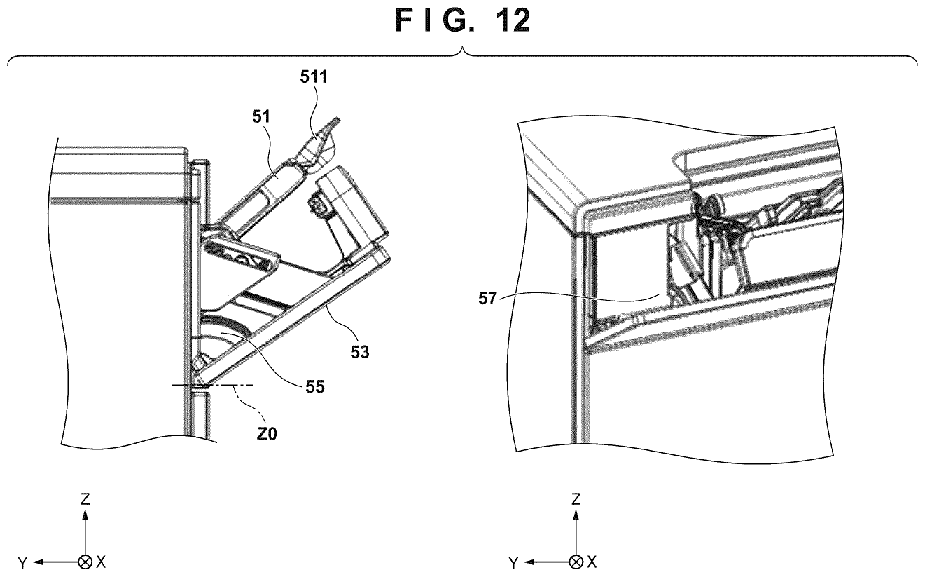

FIG. 12 is a view illustrating the open state of the front feeding unit cover 53. As illustrated in FIG. 12, the front feeding unit cover 53 includes a cam portion (cam mechanism) 55. The cam portion 55 has a width substantially engaged with a shaft portion 57 included on the main body 100 side of the apparatus, and the shaft portion 57 is guided to the cam portion 55 at the time of opening/closing of the front feeding unit cover 53. By this, a lower end surface Z0 of the front feeding unit cover 53 rises with the movement of opening of the front feeding unit cover 53, and is always at a position on a +side in the Z direction from a lower end position Z1 in the closed state illustrated in FIG. 9A.

### Opening/closing of Feeding Tray

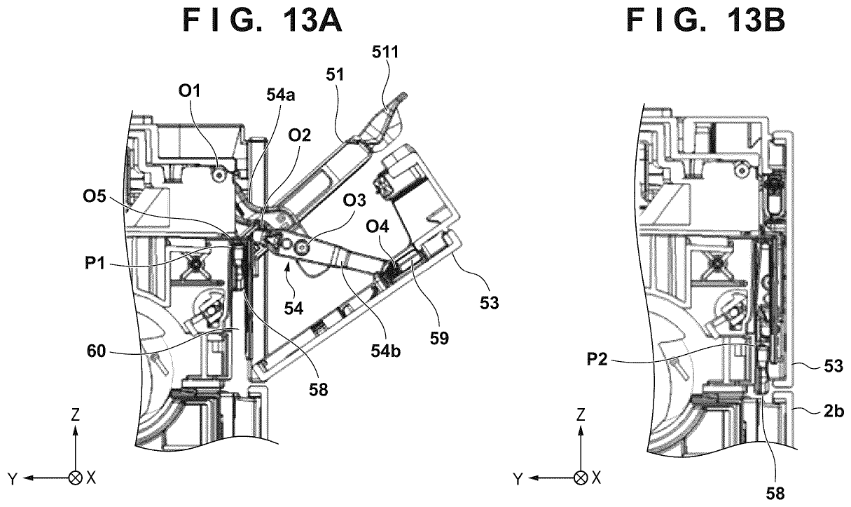

Opening/closing of the feeding tray 51 will be described with reference to FIGS. 13A and 13B. The feeding tray (first tray) 51 that is movable includes the tray link mechanism 54 and a tray guide 58, and the tray guide 58 is axially supported by a rotation shaft O5 at a lower end portion. The tray link mechanism 54 includes a main body-side link member 54a and a cover-side link member 54b. The main body-side link member 54a has an upper end portion axially supported by a rotation shaft O1 of the main body 100 of the apparatus, and a lower end portion axially supported to be rotatable about a rotation shaft O3 with respect to the cover-side link member 54b. The cover-side link member 54b has an upper end portion axially supported to the feeding tray 51 by a rotation shaft O2, and a lower end portion axially supported to be rotatable with play in a linear direction by a rotation shaft O4 with respect to the front feeding unit cover 53.

The tray guide 58 is movably guided in the Z direction along a tray guide rail 60 on the main body 100 side of the apparatus. When the front feeding unit cover 53 is opened, the feeding tray 51 moves upward in the Z direction with the movement of the rotation shaft O5 of the lower end portion along the tray guide rail 60 of the tray guide 58. The main body-side link member 54a and the cover-side link member 54b move upward, and the rotation shaft O2 moves forward in the Y direction in conjunction therewith.

In the open state of the front feeding unit cover 53, as illustrated in FIG. 13A, the tray guide 58 is positioned at a first position P1, which is one end of the tray guide rail 60 on the +side in the Z direction. On the other hand, in the closed state of the front feeding unit cover 53, as illustrated in FIG. 13B, the tray guide 58 is positioned at a second position P2, which is one end of the tray guide rail 60 on a −side in the Z direction. In this state, the feeding tray 51 is brought into a state of being housed in the housing. When at the second position P2, the tray guide 58 is positioned inside the front feeding unit cover 53 and the cassette cover 2b, and overlaps with each of them in the Z direction.

### Automatic Opening of Feeding Sub-tray

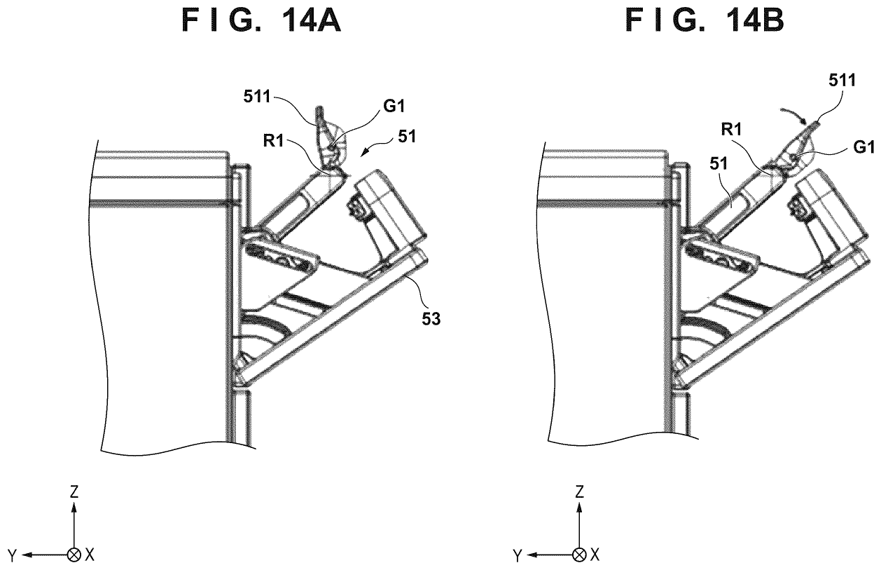

A feeding sub-tray 511 constituting the feeding tray 51 will be described with reference to FIGS. 14A and 14B. The feeding sub-tray 511 is axially supported by a leading end (upstream side in the sheet conveyance direction) of the feeding tray 51 on the +side in the Z direction so as to be rotatable about a rotation shaft extending in the X direction. As illustrated in FIG. 14A, when the feeding tray 51 is opened in conjunction with the front feeding unit cover 53, a position of a center of gravity G1 of the feeding sub-tray 511 is positioned on a −side in the Y direction relative to an axial support position R1. Therefore, when the front feeding unit cover 53 is opened, the feeding sub-tray 511 is automatically brought into an open state as illustrated in FIG. 14B. On the other hand, when the front feeding unit cover 53 is closed and the feeding tray 51 is brought into a housed state, the position of the center of gravity G1 is positioned on a +side in the Y direction (apparatus back side) relative to the axial support position R1.

### Operation Switch of Front Feeding Unit Cover Top Surface Portion

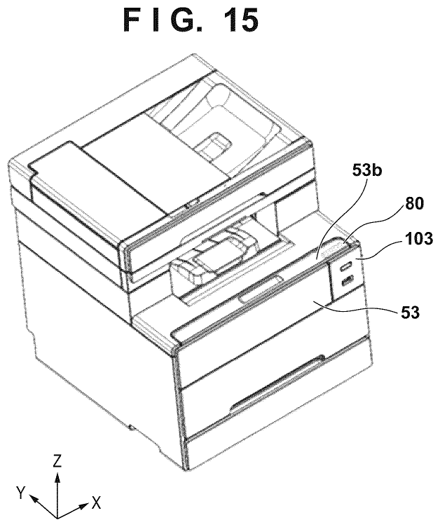

The configuration of a top surface portion of the front feeding unit cover 53 will be described with reference to FIG. 15. The fixed operation panel 103 is arranged at a position adjacent to the front feeding unit cover 53 in the X direction. The surface 53b forming a part of the top surface 101b of the apparatus of the front feeding unit cover 53 forms at least a part of the top surface of the fixed operation panel 103. A switch 80 for changing the sheet feed size (type of sheet) is arranged on the top surface side of the fixed operation panel 103, and this switch 80 is covered with the surface 53b when the front feeding unit cover 53 is in the closed state. Conversely, when the front feeding unit cover 53 is in the open state, the switch 80 is exposed and is brought into an operable state.

### Partial Configuration of Option Apparatus Sheet Conveying Path

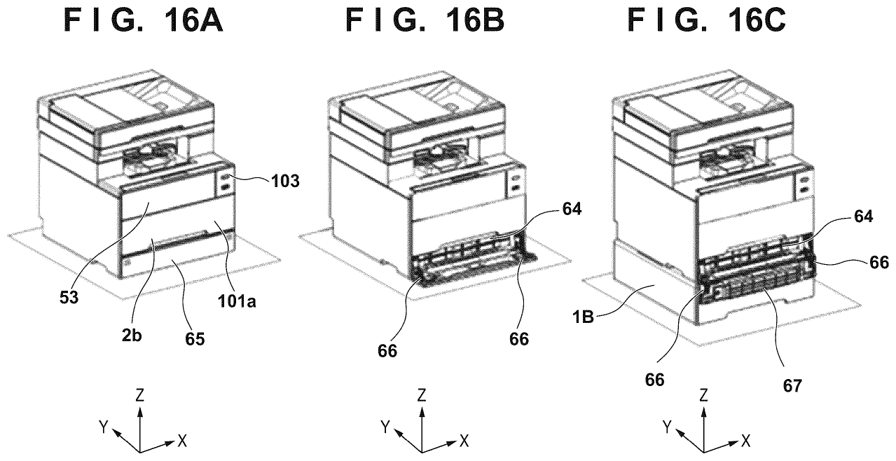

A sheet conveying path of an option apparatus will be described with reference to FIGS. 16A to 16C. In FIG. 16A, the front surface 101a of the apparatus includes the front feeding unit cover 53, the cassette cover 2b, the fixed operation panel 103, and the tank cover 65. The front feeding unit cover 53, the cassette cover 2b, and the tank cover 65 are arranged in this order from the top in the Z direction of the apparatus, and the fixed operation panel 103 is arranged at a position adjacent to the front feeding unit cover 53 in the X direction.

As illustrated in FIG. 16B, the tank cover 65 includes a tank cover hinge 66 that opens downward in the Z direction. As illustrated in FIG. 16C, the inside of the tank cover 65 includes an option sheet conveying path 67 that merges a print medium to be conveyed from an option apparatus (specifically, a supply unit of the print medium) 1B attached under the printing apparatus 1 to the main conveyance path RT1 formed by the detachable unit 40.

### Opening/closing Operation of Tank Cover

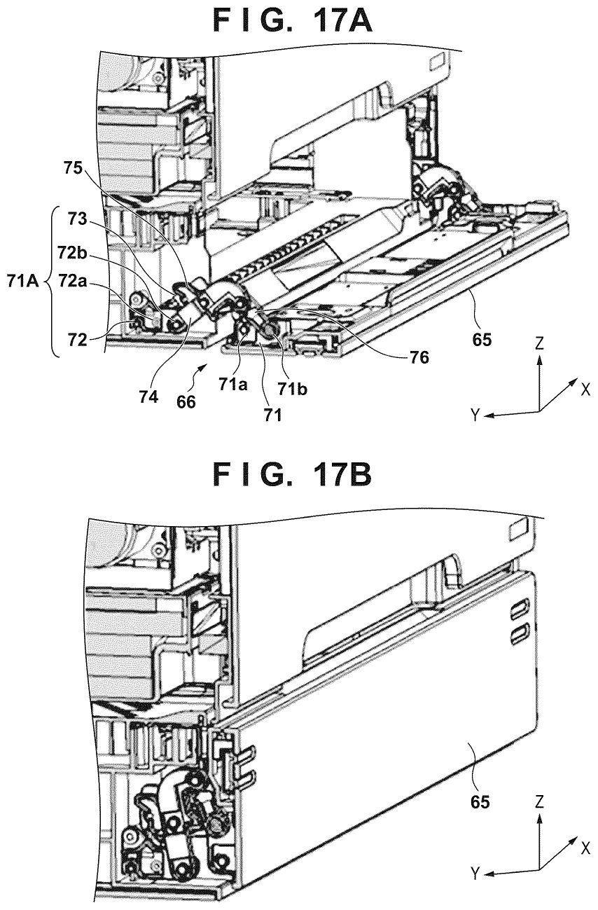

Opening/closing of the tank cover (second movable member) 65 will be described with reference to FIGS. 16A to 16C, 17A, and 17B. The tank cover 65 includes a cover first axial support portion 71a and a cover second axial support portion 71b. A first tank cover hinge 71 fixed to the tank cover 65 supports the cover first axial support portion 71a and the cover second axial support portion 71b. A second tank cover hinge 71A is configured to include an apparatus hinge 72 including a first axial support portion 72a and a second axial support portion 72b fixed to the main body 100 side of the apparatus, a first indirect hinge 73 axially supported by the first axial support portion 72a, a second indirect hinge 74 axially supported by the second axial support portion 72b, a first cover hinge 75 axially supported by the first indirect hinge 73 and axially supporting the cover first axial support portion 71a, and a second cover hinge 76 axially supported by the second indirect hinge 74 and axially supporting the cover second axial support portion 71b. The tank cover 65 can arbitrarily assume the state illustrated in FIG. 16A, the state illustrated in FIG. 16B, and the state illustrated in FIG. 16C. FIG. 16A illustrates a tank closed state in which the tank cover 65 covers the tank accommodation unit 64 in the main body 100 of the apparatus. FIG. 16B illustrates an open state in which the tank cover 65 is supported by a ground contact face so as to allow access to the tank accommodation unit 64 in the main body 100 of the apparatus. FIG. 16C illustrates an open state in which the tank cover 65 is supported in contact with the option apparatus 1B so as to allow access to the tank accommodation unit 64 in the main body 100 of the apparatus in a state where the printing apparatus 1 is placed on the option apparatus 1B that can supply the sheet SH.

### Size of Front Surface of Apparatus on Projection Surface

Note that as illustrated in FIGS. 16A to 16C, the front surface 101a of the apparatus is configured such that the end portions in the X direction and the Z direction in a projection direction from the front surface of the apparatus are smaller than the apparatus outer shape of the printing apparatus 1.

### Maintenance Cartridge Arrangement Configuration

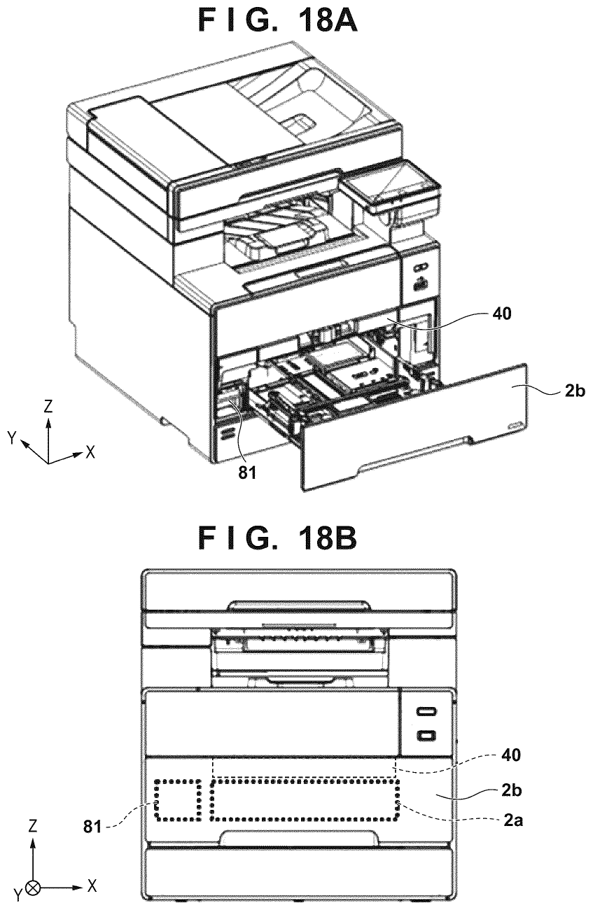

FIGS. 18A and 18B are views illustrating an open state of the cassette cover 2b. As illustrated in FIGS. 18A and 18B, the cassette cover 2b is configured so as to cover the width of the front surface 101a of the apparatus in the X direction. The feeding tray 2a is arranged on the apparatus-inner side of the cassette cover 2b, and a waste ink accommodation unit (container) 81 that accommodates waste ink (waste printing material) generated in the printhead 12 is arranged at a position adjacent to the feeding tray 2a in the X direction. The waste ink accommodation unit 81 is drawable with respect to the housing 101.

As described above, according to the above embodiment, since the front surface of the printing apparatus includes only the fixed operation panel including the operation member and the plurality of covers movable with respect to the printing apparatus, it is possible to maximize the opening of the internal access unit.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-026028, filed Feb. 20, 2025, which is hereby incorporated by reference herein in its entirety.

What is claimed is:

1. A printing apparatus comprising:
a printing unit that performs printing on a print medium by using printing material;
a supply unit that supplies the printing unit with the printing material;
a housing that has a front surface and a top surface on an upper side of the front surface and accommodates the printing unit and the supply unit;
a fixed operation unit that includes an operation member and is fixed to the housing, on the front surface;
a first movable member that is adjacent to the fixed operation unit, covers up to one end of the housing, and is movable with respect to the housing, on the front surface; and
a second movable member that is adjacent to the first movable member in a height direction of the first movable member, covers from the one end to an other end of the housing, and is movable with respect to the housing, on the front surface.

2. The printing apparatus according to claim 1, wherein the fixed operation unit includes an opening for inserting a cable.

3. The printing apparatus according to claim 1 comprising: a first supply mechanism that supplies the printing unit with a print medium; and the first movable member that covers the first supply mechanism, in an upper portion of the front surface of the housing, wherein the first movable member is integrally formed from the front surface of the housing to the top surface of the housing.

4. The printing apparatus according to claim 3, wherein the first supply mechanism includes a first tray that is movable on which a print medium is stacked, and a link mechanism that connects the first movable member and the first tray, and the first tray is housed in the housing in a state where the first movable member is closed and the first tray moves to a position where the print medium is stacked when the first movable member is opened.

5. The printing apparatus according to claim 4 comprising a second tray that is rotatable about a rotation shaft extending in a width direction of the first tray with respect to the first tray, on an upstream side in a conveyance direction of the print medium of the first tray, wherein a center of gravity of the second tray is on a front side of the housing relative to the rotation shaft in a case where the first movable member is in an open position and the first tray is in a position where the print medium is stacked, and the center of gravity of the second tray is on a back side of the housing relative to the rotation shaft in a case where the first movable member is in a closed position and the first tray is in a housed state.

6. The printing apparatus according to claim 3, wherein the fixed operation unit includes an operation unit for setting a type of a print medium to be stacked on the first supply mechanism, on the top surface side of the housing, a top surface of the first movable member is configured to cover the first supply mechanism and a top surface side of the fixed operation unit in a closed state, and the operation unit for setting the type of the print medium is exposed when the first movable member is opened.

7. The printing apparatus according to claim 3 comprising: an accommodation unit that accommodates the print medium; a cassette that is arranged in the accommodation unit and accommodates the print medium; and a second supply mechanism that supplies the print medium from the cassette, wherein the cassette is drawable forward of the housing, and includes an appearance cover, which is the second movable member.

8. The printing apparatus according to claim 7 comprising a container that accommodates waste printing material generated in the printing unit, in a position adjacent to the cassette, wherein the container is drawable forward of the housing, and is covered with the appearance cover in a state of being accommodated in the housing.

9. The printing apparatus according to claim 7, wherein the first movable member has a shape that is continuous with the appearance cover and extends toward a back side of the housing in a closed position.

10. The printing apparatus according to claim 3, wherein the first movable member includes a cam mechanism in which a lower end rises upward when moving from a closed position to an open position.

11. The printing apparatus according to claim 1, wherein a container accommodating the printing material is drawable forward of the housing, and the container is covered with a third movable member in a state of being accommodated in the housing.

12. The printing apparatus according to claim 11, wherein the third movable member is opened by rotating downward relative to the housing.

13. The printing apparatus according to claim 11, wherein a supply unit that places the printing apparatus and supplies a print medium can be mounted under the housing, and a print medium supplied from the supply unit is conveyed to the printing unit from between the third movable member and the container.

14. The printing apparatus according to claim 13, wherein the third movable member contacts the supply unit in an open position.

15. The printing apparatus according to claim 11, wherein the first to third movable members are configured to have a lateral width that is smaller than a width of the printing apparatus in a case where the printing apparatus is viewed from a front surface.

16. The printing apparatus according to claim 11, wherein the front surface of the housing includes only the fixed operation unit and the first to third movable members.
